(19) United States
(12) Patent Application Publication
(10) Pub. No.: US 2009/0314616 A1
(43) Pub. Date: Dec. 24, 2009

(54) Swtich, Method and System For Switching The State of a Signal Path

(76) Inventor: Joachim Oberhammer, Stockholm (SE)

Correspondence Address: SCHWEGMAN, LUNDBERG & WOESSNER, P.A., P.O. BOX 2938, MINNEAPOLIS, MN, 55402, US

(21) Appl. No.: 12/087,962

(22) PCT Filed: Jan. 19, 2007
(86) PCT No.: PCT/SE2007/050032

§ 371 Date: Oct. 20, 2008

(30) Foreign Application Priority Data
Jan. 20, 2006 (SE) 0600140-8

(51) Int. Cl. H01H 57/00

(52) U.S. Cl. 200/181

(57) ABSTRACT

The invention relates to a method, a system and a multi stable arranged to switch the configuration of the signal path for electrical signals comprising a first moving element (12) and a second moving element (14), wherein the first and second element can be arranged into at least two mechanically stable states: a mechanical interlocked state, wherein the first moving element is mechanically interlocked with the second moving element wherein a signal path in the switch is arranged in a closed configuration; and a non interlocked state, wherein the first moving element is separated from the second moving element and the signal path in the switch is arranged in an open configuration; wherein the switch further comprises a fixated electrostatic electrode (10) configured with a first fixated electrode part arranged to actuate and move at least one of the moving elements when an electrical potential difference is applied between the first fixated electrode and at least one of the moving elements, transitioning the moving elements from one state to another.

### FIELD OF THE INVENTION

The present invention relates to a method for opening or closing an electrical signal line by means of a mechanical switch and a switch as such, according to the pre amble of the independent claims.

### BACKGROUND TO THE INVENTION

A major issue in MEMS (micro electromechanical systems, i.e. devices that are measured in micrometers) metal-contact switch design is the choice of the contact material. In contrast to macroscopic relays with contact forces typically larger than 100 mN, MEMS switches are equipped with relatively weak actuators generating contact forces in the range of 10 μN to 5 mN only. The dependence of the contact resistance on the contact force has been thoroughly investigated for different contact materials. According to the literature, a stable contact resistance can be achieved at a force of 50-100 μN for gold, 100 μN for a gold-copper-cadmium ‘fine-gold’ alloy, 300-450 μN for a gold-(5%)nickel ‘hard-gold’ alloy [9], 300 μN for palladium, 600 μN for silver, and 600-900 μN for rhodium. It is difficult to compare the many different results since they heavily depend on the material deposition process, the contact cleaning procedure, surface contamination, the atmospheric environment, the measurement current, and the switching history. Furthermore, many investigations were carried out on test set-ups and not on fabricated MEMS devices. In general, the contact resistance decreases with increasing contact force. This relationship is explained by the contact surfaces adapting to each other due to elasto-plastic deformation, finally resulting in a sufficiently large effective contact area and thus in a stable contact resistance, which occurs for softer materials with low hardness at lower forces than for harder materials.

Therefore, soft metals are preferred over hard materials for microrelay contacts. Especially gold was found to be very suitable because of its low electrical resistance, high thermal conductivity, ease to process with a variety of available deposition processes, high oxidation resistance, relatively high melting temperature for being a soft metal, and its good resistance to absorption of surface contaminants.

However, due to their low hardness, soft metals typically also develop much larger adhesion forces with increased susceptibility for permanent contact stiction, resulting in decreased contact reliability. Typical release forces needed to separate microswitch contacts are 100-2700 μN for gold, up to 300 μN for a gold-(5%)nickel alloy, and 100 UN or less for rhodium. Thus, the adhesion forces between soft metal contacts are much larger than the necessary contact forces to close them, and for harder materials it is the other way around

A switch design equipped with gold contacts achieved a cold-switching life time of about 10 million switching cycles before irreversible contact stiction occurred, whereas the same design with ‘a platinum group’ metal contacts, exceeded 100 billion switching cycles. Thus, gold contacts have superior electrical contact performance but, if not additionally hardened by alloying elements, result in inferior life times in ‘conventional’ switch designs, which typically are not developing large opening forces.

Contact and restoring forces in the ‘conventional’ switch design. The most promising MEMS switch designs, in terms of reliability and suitability for high-volume wafer-scale manufacturing techniques, are based on electrostatic actuators, that is, actuators based on electrostatic forces. This actuation principle is of high interest for generating moving microsystems because of the high-energy densities and large forces due to the scaling laws in small dimensions, and because of relatively simple fabrication.

The conventional, most-commonly used electrostatically actuated switch concept is based on a cantilever-spring or membrane-spring structure, as shown in FIG. 1b. The actuator mechanism features active closing by the electrostatic force and passive opening by the spring energy stored in the deflected, i.e. pulled in, structure. Assuming a simplified model with parallel-plate electrodes, the electrostatic force is proportional to (d0−d)² with d0 the initial electrode distance and d the deflection of the cantilever. About 40-90% of the total electrostatic force is typically used as the contact force, with the remainder part contributing to beam flexture or being lost by touching electrodes or the anchor suspension. The counter-acting restoring spring force is directly proportional to d. The actuator has to be de-signed that the electrostatic force at ⅔ of the initial electrode distance d0 is larger than the spring force, otherwise a pull-in does not occur. This criterion in connection with the nonlinear growing electrostatic force results in a very large contact force in the final contact position dmax, but only in a comparatively small restoring spring force.

FIG. 2 shows a plot of the contact and restoring forces over the cantilever deflection, plotted for the critical pull-in case of a parallel-electrode model. The contact force of switches of this conventional type is typically in the range of 100-500 μN, but the restoring force is usually much lower than 100 μN, which makes this concept less suitable for soft contact materials. Increasing the spring force for improving the contact separation force requires an even stronger, thus larger electrostatic actuator or very high actuation voltages. From an actuator-volume energy-efficiency point of view such an actuator is ‘overkill’, since its size and capability are by far not utilized for fulfilling its function, which is to provide with a sufficiently large contact and restoring force in the contact position. Thus, the conventional electrostatic switch concept based on an active contact and passive restoring force, definitively a good choice for medium-hard contact materials, is less suitable for soft contact materials. Furthermore, the pull-in requirements for the conventional concept result in an oversized actuator since its strong contact force is not needed for soft contact materials.

Most bi-stable microrelays are based on laterally moving, linear displacement electrothermal actuators, whose bi-stability is based on the buckling of multi-cantilever structures in two stable positions. Here, the electro thermal actuator is only being used to provide with the energy for triggering the transition to the other stable state. Other laterally moving bi-stable mechanisms utilize an actuator for the displacement of the main structure and a secondary actuator for locking the main structure with movable hooks to prevent it from retreating to the initial position after removing the external actuation energy. A characteristic property of these types of devices is that neither the buckling mechanism nor the actuator is creating their maximum force in one of the end-positions of the movement, which would be desirable for microrelay applications. Vertically moving structures are less suitable for bi-stable mechanisms which require complex geometrical elements in the plane of movement, thus, featuring fabrication procedures of laterally moving actuators.

The object of the invention is to provide a method and device to enhance the actuation and performance of a mechanically multi-stable switch mechanism.

### SUMMARY OF THE INVENTION

The present invention solves the above stated object by providing a method, device and system according to independent claims 1, 15 and 21.

The present invention discloses a multi stable switch arranged to switch the configuration of the signal path for electrical signals comprising a first moving element and a second moving element, wherein the first and second element can be arranged into at least two mechanically stable states: a mechanical interlocked state, wherein the first moving element is mechanically interlocked with the second moving element wherein a signal path in the switch is arranged in a closed configuration; and a non interlocked state, wherein the first moving element is separated from the second moving element and the signal path in the switch is arranged in an open configuration; wherein the switch further comprises a fixated electrostatic electrode configured with a first fixated electrode part arranged to actuate and move at least one of the moving elements when an electrical potential difference is applied between the first fixated electrode and at least one of the moving elements, transitioning the moving elements from one state to another.

Additionally, the multi stable switch may be embodied, wherein the first fixated electrostatic electrode further comprises a second fixated electrostatic electrode part arranged along the second moving element and the first fixated electrode part is arranged along the first moving element.

Additionally, the multi stable switch may be embodied, wherein the moving elements have one fixating anchor point each arranged at a small distance from the fixated electrode, and a tip arranged at a greater distance than the anchor point from the fixated electrode.

Additionally, the multi stable switch may be embodied, wherein the tips of the moving elements are arranged in shapes to assist the interlocking between the first moving element and the second moving element.

Additionally, the multi stable switch may be embodied, wherein the interlocked state of the moving elements is maintained by a force created by a restoring mechanical spring force of at least one of the moving element that is deflected in the mechanically interlocked state.

Additionally, the multi stable switch may be embodied, wherein the switch comprises distance keepers or dielectric isolation layers arranged to separate the fixated electrostatic electrode and at least one of the moving elements.

Additionally, the multi stable switch may be embodied wherein the switch is further arranged to switch the electrical signal between an input and two outputs or between two inputs and an output.

Additionally, the multi stable switch may be embodied, wherein the switch comprises a third moving element and the fixated electrostatic electrode comprises a third fixated electrode part arranged to deflect the third moving element towards the third fixated electrode part when an electrical potential difference is applied between the third moving element and the third fixated electrostatic electrode part, and wherein the first, second and third element can be arranged into at least three stable states: a mechanical interlocked state, wherein the first moving element is interlocked with the second moving element; a second mechanical interlocked state, wherein the second moving element is interlocked with the third moving element; and a non interlocked state, wherein none of the moving elements is interlocked to any of the other moving elements.

Additionally, the multi stable switch may be embodied wherein the switch is a MEMS switch, i.e. a device fabricated by micromachining technology.

Additionally, the multi stable switch may be embodied wherein the moving elements have a shape of a cantilever beam.

Additionally, the multi stable switch may be embodied wherein the electrode parts of the fixated electrostatic electrode are separate electrodes electrically separated from each other.

Additionally, the multi stable switch may be embodied wherein the fixated electrode part/s is curved.

Additionally, the multi stable switch may be embodied wherein each moving element comprises a signal path arrangement and an actuation electrode wherein the signal path arrangement is separated from the actuation electrode on the moving elements.

Additionally, the multi stable switch may be embodied wherein the elements of the arrangement, including the fixated electrode, are arranged in a way that the disturbance of the signal propagation of high frequency signals, including microwave and millimetre wave, is minimized.

The invention further discloses a method for the transition of a switch configuration from a first stable state to a second stable state wherein the switch comprises a first moving element, a second moving element, and a fixated electrostatic electrode with a first fixated electrostatic electrode part; wherein the method comprises the steps of applying an electrical potential difference between the first fixated electrostatic electrode and the first moving element, forcing the first moving element to deflect towards the fixated electrode by electrostatic force; and releasing the electrical potential difference resulting in that the first and second moving element are positioned into the second stable state.

The method may further be a method wherein the two stable states are: a mechanical interlocked state, wherein the first moving element is interlocked with the second moving element and an electrical signal path in the switch is non interrupted; and a non interlocked state, wherein the first moving element is separated from the second moving element and the electrical signal path in the switch is interrupted.

The method wherein may further disclose a method wherein the fixated electrostatic electrode comprises a second fixated electrostatic electrode part method further comprises the steps of: applying an electrical potential difference between the second fixated electrostatic electrode part and the second moving element, forcing the second moving element to deflect towards the fixated electrode by electrostatic force; and releasing the electrical potential difference between the second fixated electrostatic electrode part and the second moving element.

The method may be embodied wherein the applying and releasing of electrical potential difference between the first fixated electrostatic electrode part and the first moving element and the applying and releasing of electrical potential difference between the first fixated electrostatic electrode part and the second moving element are following a certain sequence.

The method may further disclose a method, wherein the switch comprises a third moving element and the fixated electrostatic electrode comprises a third fixated electrostatic electrode part, wherein the method further comprises the steps of; applying an electrical potential difference between the third fixated electrostatic electrode part and the third moving element, forcing the third moving element to deflect towards the third fixated electrostatic electrode part by electrostatic force; and releasing the electrical potential difference between the third fixated electrostatic electrode part and the third moving element, resulting in that the first and/or the second moving element, and the third moving element are arranged in a third stable state interconnected to each other.

The switch in the method may further disclose that the electrode parts of the electrostatic electrode are separated parts.

The invention further discloses a system arranged to switch electrical signals comprising a first and a second multi stable switch according to what is stated above, arranged adjacent to each other forming an array of switches in a switch matrix.

The invention allows a mechanically multi-stable switch mechanism with enhanced performance and actuation resulting in a switch of smaller size, higher efficiency and less complex. This in turn enhances the economics in the fabrication, due to the fact that it is more suitable for high-volume fabrication]

In an embodiment of the invention the device is operated by electrostatic curved-electrode actuators which are based on a flexible and a fixed electrode, with the electrode distance gradually increasing from the clamped end to the free end of the moving structure. Due to the narrow gap in the beginning, high forces initialize the movement of successive parts of the flexible electrode, and the short electrode distance and thus the location of the large actuation force is moving along the fixed electrode in a zipper-like way. Such an actuator achieves very large deflection comparable to electro thermal actuators at medium actuation voltages. Furthermore, in contrast to electro thermal actuators, the maximum force is created in the end-position of the movement, which makes them very suitable for electrical microswitches.

### BRIEF DESCRIPTION OF THE DRAWINGS

The invention, together with further objectives and advantages thereof, may best be understood by reference to the following description taken in conjunction with the accompanying drawings in which:

FIG. 1 is showing schematic drawings of (a) ‘active opening force/passive contact force’ switch concept with the electrostatic force of a laterally moving, curved electrode actuator utilized to separate the switching contacts with a very large active opening force; (b) conventional concept of a vertically moving cantilever beam with the electrostatic actuator, typically in parallel-electrode configuration, utilized to close the switch contacts, and only a small passive restoring force created by the spring energy stored in the deflected cantilever;

FIG. 2 shows the forces acting in a simplified parallel-electrode model of the conventional cantilever-spring or membrane-spring switch design, plotted for the critical case where the electrostatic force is just large enough for guaranteeing a successful pull-in. In the contact position, the switch develops an unnecessarily large electrostatic force, but, if not substantially oversized, only a relatively small restoring spring force. d0 is the initial distance between the actuator electrodes;

FIG. 3 shows actuation phases of the mechanically bi-stable, “active opening force/passive contact force” switch mechanism according to an embodiment of the invention;

FIG. 4 shows a qualitatively comparison of the forces acting in the conventional and the new switch design. The ‘active opening force/passive contact force’ switch is capable of overcoming much larger adhesion forces and is therefore more suitable for soft contact materials;

FIG. 5 shows forces between the switch contacts to open and to close the switch: (a) conventional switch concept; (b) ‘active opening force/passive contact force’ switch concept. As shown in the drawing, the forces in the x-direction are larger than the forces in the y-direction, since the vertical cantilever of the fabricated devices investigated in this paper is more deflected in the interlocked position than the horizontal cantilever, which results in closer electrode approximation of the vertical cantilever;

FIG. 6 shows a SEM picture of two switches of the ‘active opening force/passive contact force’ switch design, based on two perpendicularly arranged cantilevers with interlocking hooks deflected by curved-electrode actuators;

FIG. 7 shows a close-up view of the cantilever tips with the two interlocking hooks. The central stopper and parts of the curved electrode are visible as well;

FIG. 8 shows simulated equivalent tip forces for active opening and passive closing of the switch contacts of design III, for different cantilever deflections;

FIG. 9 shows opening-force/contact-force diagram with a plot of the contact resistance over the contact force for gold switch contacts. The safe, critical and unsuitable design regions are shown. Conventional switch designs ((a) switch by Radant MEMS, Inc.; (b) EL switch) are not creating reliable opening forces for pure gold contacts, unless a very strong actuator is used ((c) switch by OMRON Corp.). The novel ‘active opening force/passive contact force’ designs ((d1), (d2), (d3)) fit the gold material properties better.

FIG. 10 shows the SEM-picture of a mechanically tri-stable, single-pole-double-throw (SPDT) switch with one input and two output cantilevers, thus three curved electrode actuators in total, whereas the middle actuator can move both to the left and to the right.

FIG. 11 shows single actuation phases for switching a locking mechanism between off-state and on-state;

FIG. 12 shows a close up view of the interlocking elements in the off-state; the cantilevers have very low spring constants of less than 10 Nm⁻¹, resulting in image jitter of the input cantilever due to actuation by the electron beam in the SEM;

FIG. 13 shows a close up SEM picture of the interlocking elements in one of the two one states: input closed to output 1.

FIG. 14 shows lateral and longitudinal cross sectional drawings of a switch cantilever;

FIG. 15 shows actuation voltages for three switch designs with different cantilever thickness: pull-in voltages of the input and the output cantilevers, and voltage to open the switches;

FIG. 16 shows burn-in behaviour of the switching contacts: total switch impedance of the first ten switching cycles. After five cycles, the impedance drops to a constant value due to surface adaptation between the soft gold contacts;

FIG. 17 shows a failure mechanism of a switch variant: design with too short stopper tip resulting in permanent stiction of the cantilever to the curved electrode;

FIG. 18 shows the typical concept of a curved-electrode actuator with no voltage applied;

FIG. 19 shows a curved-electrode actuator with voltage applied;

FIG. 20 shows a typical switch device based on two curved electrode actuators with one movable element each;

FIG. 21 shows a configuration with four curved-electrodes and three moving elements;

FIG. 22 shows a flow chart of a method according to an embodiment of the invention;

FIG. 23 shows a number of designs for switching microwaves or radio signals; and

FIG. 24 shows the actuation phases for a design in FIG. 23.

### DETAILED DESCRIPTION OF EMBODIMENTS OF THE INVENTION

Mechanically bi-stable switch actuators are mechanisms which, in contrast to most commonly used switch mechanisms, maintain both of their static states (on-state and off-state) without applying an external energy source which is only needed to carry out the transition between the stable states. These types of actuators are the preferred choice for many switch applications with requirement on the maintenance of their switch positions during unpredicted or deliberate power outage, and for applications demanding extremely low power consumption. Examples are reconfigurable electrical or optical networks.

A multi-stable switch mechanism is a mechanism with at least two mechanically stable states, i.e. states which maintain their configuration for an undetermined length of time without applying any external energy. An example of a multi-stable switch mechanism is a tri-stable single-pole-double-throw switch, which has one input port and two output ports, and the three mechanically stable states are: input port to output port 1, input port to output port 2, and input port not connected to any of the output ports.)

An embodiment of the invention concerns a concept for MEMS (micro electromechanical systems) metal-contact electrical signal switch circuits. Such a MEMS switch is basically a microrelay which is a micromechanical device mechanically switching electrical signals by using MEMS technology based actuators. The frequency range of the signal to be switched may either be limited to any frequency band or maybe a wide spectrum from DC to microwaves and above frequencies. Such switches are of millimetres or sub-millimetres dimensions with the true ohmic metal-contact switching behaviour of macroscopic relays (low resistance when switched on; very high isolation when switched off), but of very small dimensions and with the possibility of being fabricated by, for example, high-volume semiconductor or Microsystems fabrication facilities, resulting in low cost per device since the size of a single device is very small which allows for a large number of devices being fabricated in parallel on a single substrate and thus significantly breaking down the cost per device. In the following, a switching structure is referred to as “switch” or as “device”. Further commonly used synonyms are “microswitch”, “microrelay”, or “MEMS switch”.

A metal-contact MEMS switch is a MEMS switch opening and closing a interrupted signal line by moving a metal contact bar closing or opening the signal line. Such a device is able to switch DC (direct current) signals and AC (alternating current) signals. A stable state of a reconfigurable device is a state which is maintained either with or without applying an external or internal energy or power. A stable state is characterized by the moving elements of the reconfigurable device being in certain defined positions which do not change without a change in the external influence to the device. The different stable states distinguish from each other by the fact that at least one movable element is in a different position than in at least one of the other stable states of the reconfigurable device. A stable state refers to a stable configuration of the mechanical elements of the device.

A mechanically stable state is a state of a mechanically reconfigurable device, where this state is maintained by the device without applying any external or internal energy or power source. A mechanically bi-stable or multi-stable switch is a switch device which has two or more mechanically stable states, whereas a mechanically stable position is a stable state of the device which is maintained without applying any external or internal energy or power source. A mechanically bi-stable device has two of such mechanically stable states; a mechanically tri-stable device has three mechanically stable states. In general, a mechanically multi-stable device refers to a at least two or more mechanically stable states.

An actuator is a device or a part of a device creating a mechanical force applied to the device or parts of the device which may result in mechanical movement of parts of the device. This force or movement developed by the actuator is usually created by an external power or energy applied to the device.

An electrostatic actuator is an actuator based on at least two electrodes, of which at least one or a few or all electrodes can be movable with at least one degree of freedom. When an electrical potential difference (=voltage) is applied between at least two of the electrodes, a mechanical force between these electrodes is created, which might result in the movement of at least one electrode toward another electrode or of the electrodes toward each other.

A curved-electrode actuator is an electro-static actuator consisting of two electrodes, where one electrode 10 is rigid and curved, and the other electrode 12 is initially flat and movable with at least one degree of freedom. The initial electrode distance is very small at the anchor (=fixation point 121) of the movable electrode 12, and very large at the tip 122 of the movable structure 12. The movable electrode 12 is successively bending along the rigid electrode 10. Typically, the movable structure 12 has the shape of a cantilever beam, which is characterized by being very long as compared to its thickness, where the thickness is defined as the dimension perpendicular to its length and in parallel to the lateral direction of movement of this flexible structure. Such a curved-electrode actuator has the advantage of having a relatively large tip deflection at relatively low actuation voltages, as compared to the deflection of a parallel-electrode cantilever-spring or membrane-spring structure. An electrical signal is the signal which has to be switched by the device, i.e. its electrical signal path is reconfigured from at least one input/output to at least one input/output by the switch device. Synonyms to electrical signal path are electrical signal line or transmission line. Switching the electrical signal by reconfiguring the mechanical elements is the main function of a switch.

An embodiment of the invention claims mechanically multi-stable switch devices for switching electrical signals and being fabricated by MEMS technology or any other technology, and which are based on a mechanically multi-stable mechanism consisting of at least one electrostatic actuator 10 which may be a curved-electrode actuator which, alone or together with other actuators of curved electrode or other type, actuates at least two moving elements 12, 14 which can be mechanically interlocked for different mechanically stable states 24, representing the mechanical re-configurability of the device. Non-interlocked stable states 20 might also be suitable operation states and be utilized for re-configuring the devices, whereas these non-interlocked states 20 are general stable states. The electrical signal to be switched between different input and outputs of the device can be transmitted via the interlocking structures and is switched between at least one different input and ate least one different output for different electrical configuration of the signal paths in the switch device.

An embodiment of the switch covered by this invention consists in its basic structure of the following elements or features:
at least one or more externally or internally controlled electrostatic actuators 10 which may be curved-electrode actuators, with at least one electrode for each actuator; and the electrodes can be controlled electrically independently or dependent on each other or on other electrical parts of the device (i.e. electrodes electrically connected or not connected to each other or to other electrical elements of the device)
at least two moving elements 12, 14 with at least one degree of freedom each, where these moving elements 12, 14 have at least one fixating anchor point each 121, 141, and at least one of these moving elements is actuated by at least one of the electrostatic actuators 10,
the moving elements 12, 14 are reconfigured in their position by the curved electrode actuators 10 or by other electrostatic actuators resulting in different interlocked or non-interlocked stable states, where at least one of all possible stable states is mechanically stable,
at least one of the moving elements 12; 14 when intended for being utilized in an interlocking mechanism, are endowed with any type of tip shape 122; 142, typically a hook shape, to assist the mechanical interlocking between the elements at least one electrical signal line to be switched on-and-off or influenced by the different states of the device; in other words the possible signal paths of the electrical signal are mechanically reconfigured by the moving elements 12, 14 of the switch device
the locking and un-locking of the movable elements is done by the actuators of the device, consisting of at least one curved-electrode actuator 10.
the locking and un-locking of the movable elements 12, 14 occurs either by successive actuation of movable elements 12, 14 or by simultaneous actuation of movable elements 12, 14.
for stable states involving deflected, i.e. bended movable elements 12, 14, the force maintaining the interlocked state and the force defining the electrical contact force between the interlocked elements when they are used as apart of the electrical signal path, are created by the restoring mechanical spring force or spring energy of the deflected elements.
the actuation force for opening or un-locking interlocked elements is either created by an actuator element, such as a curved-electrode actuator 10 with external or internal energy or power source, or by the spring energy or spring force stored in the deflected element or elements.

As a special feature of curved-electrode actuators, the electrostatic force is strongly increasing with the deflection of the movable element along the curved electrode 10, and reaches its maximum in or close to the end position of the deflection. Thus, when the interlocked position of the movable structures 12, 14 is close to the maximum end position of the movement, the resulting force to open the interlocked mechanism is very large. Thus, in a typical embodiment of such a switch and in contrast to conventional MEMS switch concepts, the forces to open the mechanism (and to open the metal contacts of the switch) are created actively by the actuator, and the forces to maintain the closed (interlocked) state (contact force between the closed switch contacts), are created passively by the spring energy stored in the deflected structure(s) 12, 14. Typically, this concept results in contact opening forces much larger than the contact closing forces.

Furthermore, in a typical embodiment of such a device, parts of the switch might be shared electrically between the electrical actuation path and the electrical signal path of the switch, or might be electrically separated. In the case of electrically shared elements, one movable element 12 might consist of at least a metal element where the electrical signal path is routed via this movable element 12, and the movable element 12 acts as an actuation electrode at the same time. In this case, the interlocking point 50 between the movable elements 12, 14 maintaining the interlocked position of the movable elements, is also acting as the contact point closing the electrical signal path.

The switch might be fabricated on a substrate of any kind of material (e.g. silicon, gallium-arsenide, quartz, any type of glass) or on ceramic or plastic carriers. The switch might be fabricated completely on one substrate, or different parts of the switch might be fabricated on different substrates and finally assembled, either manually or by an automated process (such as flip-chip bonding or wafer bonding, and the like).

Furthermore, a switching device claimed by this invention may further consist of:

one or more electrical isolation layers between the electrodes. The isolation layers might be of any kind of non-metallic materials like polymers or ceramics. An isolation layer on the film might also have structural function to improve the mechanical stability of the film.

electrically isolated or to other electrical elements connected distance keeping posts or stoppers 18, to take care of the separation of at least two electrodes 12, 10 during at least one operational state of the switch. Such distance keepers 18 might replace the function of at least one electrical isolation layer.

one or more isolation layers between the electrically active parts of the device and the substrate.

additional clamping electrodes to ensure stable states by electrostatic forces between the clamping electrodes and at least one electrode on at least one moving element. The clamping electrodes on the moving elements might be connected to the actuation electrodes of the moving element, or might be controlled independently of the actuation electrodes.

vertical or lateral in-plane or out-of-plane electrical interconnection lines between different elements of the device

the device might be packaged to ensure an atmosphere suitable for its operation. That might be an electronegative single gas or gas mixture or any other gas or gas mixture. The pressure inside the package might be any degree of vacuum, normal pressure or over-pressure.

the device might be endowed with contact pads for controlling the electrodes to carry out the switch functions, and contact pads for the electrical signal(s) to be switched or reconfigured.

the moving elements may either move in one and the same geometrical plane or they may move in independent or dependent geometrical planes.

In the figures, switch devices are shown with two or three movable elements resulting in two or three mechanically stable states. In other embodiments, however, structures based on this invention are possible with more than three movable elements and more than three mechanically stable states. Furthermore, structures based on this invention with at least two movable elements 12, 14 resulting in at least two mechanically stable state 24 and in no or at least one general stable state 20 are possible as well.

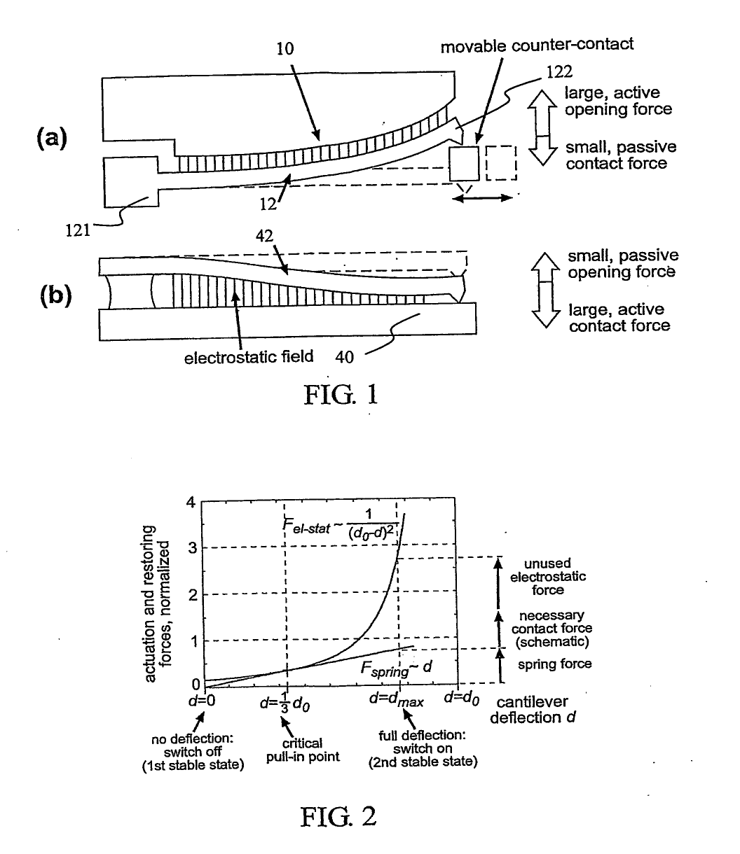

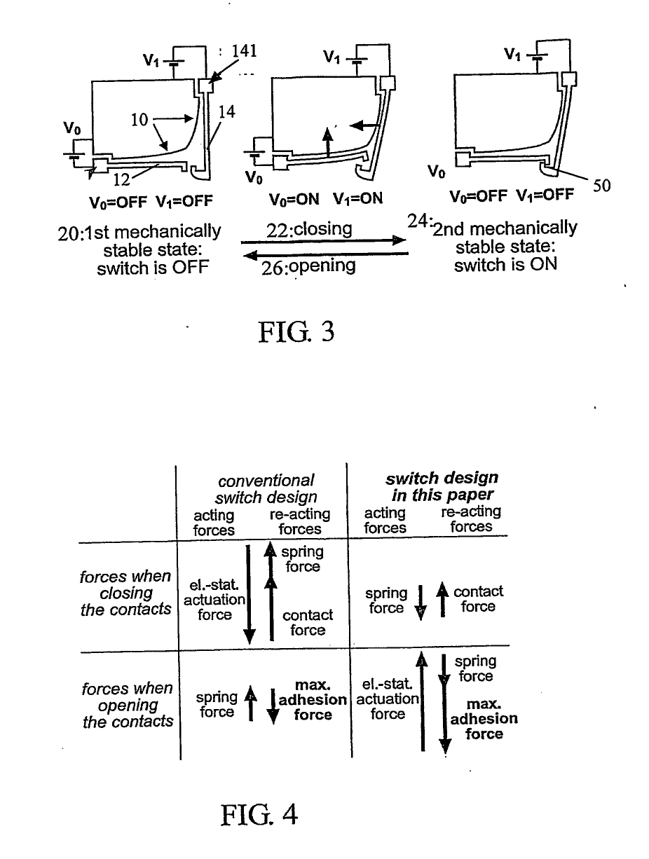

This embodiment presents and investigates a laterally moving metal-contact switch concept whose actuator, in contrast to conventional switch designs, is utilized for actively opening the switch contacts as illustrated in FIG. 1a. This concept provides with a large, externally controllable opening force suitable to overcome contact stiction even for soft-metal contacts. Furthermore, the switch is based on a mechanically bi-stable mechanism consisting of two electrostatic actuators such as curved electrode actuators, whose cantilever tips 122, 142 are endowed with interlocking hooks. Basically, any on-off type microswitch is bi-stable, but typically only one of the two stable states is mechanically stable, i.e. stable without applying any external energy. For the present switch as for any other mechanically bi-stable mechanism, the power supply is only needed for triggering the transition between the two states. FIG. 1 is showing schematic drawings of (a) ‘active opening force/passive contact force’ switch concept with the electrostatic force of an actuator with a laterally moving cantilever 12 and a curved electrode 10 utilized to separate the switching contacts with a very large active opening force; (b) conventional concept of a vertically moving cantilever beam 42 with the electrostatic actuator 40, typically in parallel-electrode configuration, utilized to close the switch contacts, and only a small passive restoring force created by the spring energy stored in the deflected cantilever. FIG. 3 shows the principal actuation phases of the novel switch mechanism in the two stable states 20, 24 and during the transition 22, 26. In contrast to conventional metal-contact switch designs featuring active contact closing and passive opening, the actuator of the presented switch is utilized for actively opening 26 the switch contacts, and the contact force is created by the passive spring energy stored in the deflected cantilevers 12, 14. For interlocking the hooks, the cantilevers 12, 14 have first to be moved to their maximum deflection and then, one after the other, relaxed to the interlocking position. Curved-electrode actuators and other types of electrostatic actuators develop their maximum force in the deflected end-position, provided that the deflected cantilever 12, 14 touches neither the electrodes 10, nor the stoppers 18.

Curved-electrode actuators are based on an electrode geometry with the electrode distance gradually increasing from the clamped end 121, 141 to the free end of the moving structure 12, 14. Due to the narrow gap in the beginning, high forces initialize the movement of successive parts of the flexible electrode and the short electrode distance and thus the location of the large actuation force is moving along the fixed electrode 10 in a zipper-like way. The advantage of such actuators is a large tip deflection at substantially lower actuation voltages as compared to parallel electrode designs. Curved-electrode actuators develop their maximum electrostatic force in the deflected end-position where the distance between the electrodes is very small, as illustrated in FIG. 1a. The cantilevers of the presented switch concept are deflected close to their maximum displacement when they are interlocked in the on-state. Thus, the design utilizes the actuators close to their best operating point to develop a maximum opening force for separating the switch contacts. Also, a large deflection of the cantilevers in the interlocked position results in a spring force large enough for creating the contact force between the two interlocked cantilevers 12, 14.

The restoring spring force of any electrostatically actuated cantilever-spring or membrane-spring system with pull-in capability is much smaller than its full-deflection actuation force (see FIG. 2). That means for the presented switch design with two similar-sized cantilevers, that the contact force created by the spring energy in the deflected cantilever may be much smaller than the electrostatic opening force, and also much smaller compared to the contact force of a conventional switch design. For designing the contact force, the same rules apply as for designing the opening force in a conventional switch design: a cantilever with large spring constant increases the force, but also increases the necessary switch actuation voltage. The “passive contact/active opening force” switch is capable of overcoming much larger adhesion forces and therefore more suitable for soft contact materials as for designing the opening force in a conventional switch design: a cantilever with large spring constant increases the force, but also increases the necessary switch actuation voltage.

FIG. 4 shows a qualitative comparison of the forces in the new switch concept in contrast to the forces in the conventional switch design. For a fair comparison, the switches representing the two drawings are assumed to have equal strong electrostatic actuators and cantilevers with equally stiff spring constants. The main difference is that the new concept is able to overcome much larger adhesion forces between the switch contacts, since almost the whole electrostatic actuation force, only reduced by the spring force, is contributed to separate the switching contacts. The very large opening force and the small, but for soft metal contacts sufficiently large contact force make this switch concept much more suitable for soft-metal contact materials than the conventional switch concept. Furthermore, the actuator is more energy-efficient, since it is operated close to its best mechanical operating point for separating the closed switch contacts. Thus, oversizing of the actuator, definitively necessary to adapt a conventional switch design to soft metal contacts, is not necessary.

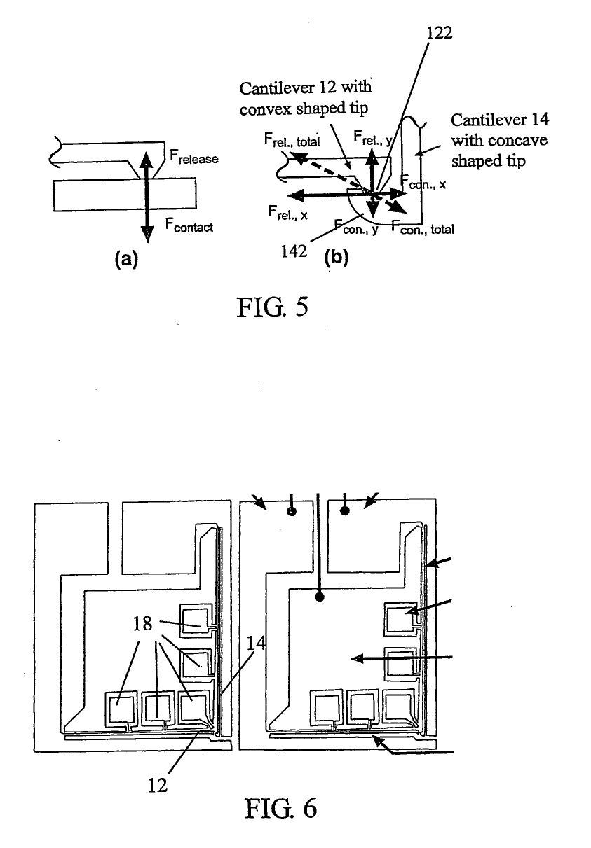

It is also interesting to note that for the present switch design, the actuation voltage to open the switch may be applied simultaneously on both cantilevers, since the cantilevers in the on-state are interlocked and thus electrically connected. Thus, the total opening force consists of two components perpendicular to each other, as shown in FIG. 5. Having both a horizontal and a vertical, even though not independently controllable, force component acting on the adhering contacts might also result in an improved condition for the contact separation physics, since the contact surfaces are not flat on a nano-scale but have a three-dimensional topography due to surface roughness. The main advantages of the new switch concept are summarized as

large active opening force

suitable for soft contact materials

mechanically bi-stable or multi-stable (two or more than two stable states)

simple, low-cost fabrication, (possible already with only one photolighographic mask)

all-metal design possible, i.e. dielectric isolation layers can be omitted (no charging problems of isolation layers)

energy-efficient actuator (no actuator oversizing)

opening force with at least one component which may improve the contact physics.

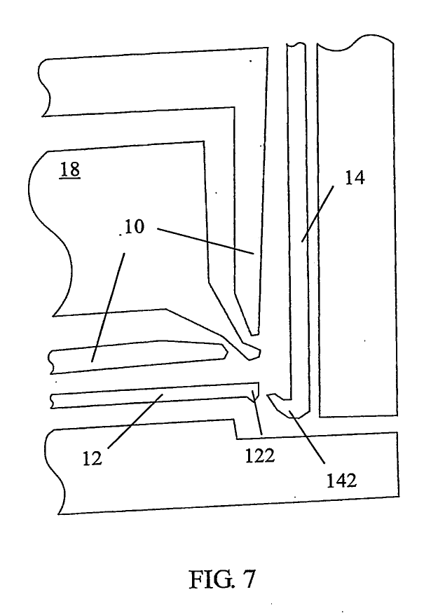

In embodiments of the invention the mechanically bi-stable switches have been fabricated in three different design variants with a total cantilever beam thickness of 3.6, 4.1, and 4.6 μm (design I, II, and III, respectively). Each switch consists of two cantilevers. The cantilever with the convex-shaped hook-tip (see FIG. 5b) has a length of 300 μm, and the cantilever with the concave shaped tip has a length of 400 μm. The devices have been fabricated by deep-reactive-ion-etching (DRIE) in a silicon-on-glass substrate with a 60 μm silicon device layer. The total cantilever thickness consists of the silicon core plus a sputtered gold cladding layer with a sidewall thickness measured to 450-500 nm. The gold layer serves as the contact material and increases the electrical conductivity of the cantilevers. Since the electrodes are not covered by isolation layers, each actuator is endowed with three stoppers 18 distributed along the curved electrodes 10, which are electrically isolated posts keeping the distance between the cantilever and the curved electrode when a pull-in occurs and thus preventing both an electrical short circuit and stiction between the electrodes. A SEM-picture of two switches is shown in FIG. 6, and a close-up view of the cantilever tips 122, 142 is shown in FIG. 7.

The measured and simulated pull-in voltages of the three basic switch design variants according to the embodiment above are summarized in Table I.

TABLE I
MEASURED AND SIMULATED PULL-IN VOLTAGES OF
THE THREE BASIC SWITCH DESIGN VARIANTS.

| | actuation voltages in V measured (simulated) | | |
|---|---|---|---|
| | design no. | | |
| | I | II | III |
| cantilever thickness | 3.6 μm | 4.1 μm | 4.6 μm |
| 400 μm cantilever | 30.8 (33.1) | 38.7 (41.1) | 43.5 (49.5) |
| 300 μm cantilever | 45.2 (46.3) | 56.4 (57.3) | 63.1 (69.0) |

THE CANTILEVER THICKNESS REFERS TO THE TOTAL THICKNESS MEASURED ON FABRICATED DEVICES, INCLUDING THE GOLD COATING LAYER.

The measured actuation voltages are very well reproducible with a standard deviation of 0.62 V of 10 subsequent measurements of the 300 μm, and 1.93 V of the 400 μm long cantilevers, respectively. As shown in Table I, the measured values correspond to the simulated pull-in voltages with an accuracy of 10% or better. The actuation voltage to actively open the switches is not as well reproducible and varies for design I with 3.6 μm thick cantilevers between 48 and 65 V. The large variation in the voltage required to open the switch is caused by the adhesion of the closed contacts, which is a rather unknown factor and depends on different and unpredictable conditions at each switching cycle. For evaluating the contact separation voltage, the devices were cold-switched, i.e. the signal current of 1 mA was applied in each closed state for at least 10 s, but removed during the switch transition. For the different cantilever thicknesses of 3.6, 4.1, and 4.6 μm (design I, II, and III), the average opening voltage was measured to 56.5, 60.6, and 85.0 V, respectively.

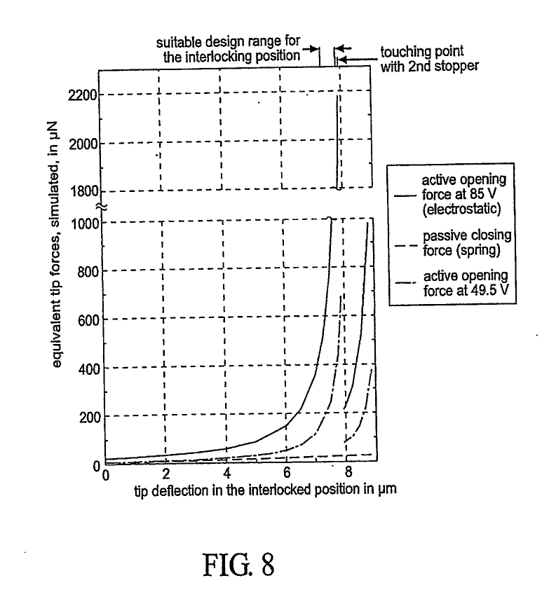

FIG. 8 shows a plot of the simulated contact and opening forces over the tip deflection of the 400 μm long cantilever of design III. The displayed equivalent tip forces are the forces which would have to be applied at the cantilever tip to compensate for the total torque imposed on the cantilever by the electrostatic force distribution. Due to the decreasing electrode distance at larger deflection d and the (d0−d)−2 correlation between the distributed electrostatic force and the local cantilever deflection, the opening force is growing much faster then the counteracting spring force, similar to the contact force in a conventional switch design as displayed in FIG. 2. The discontinuity of the simulated opening force at a tip deflection of about 7.9 μm stems from the cantilever touching the second stopper, which counteracts to a large amount of the electrostatic force. With further increasing tip deflection, the equivalent tip force is growing again, until the cantilever finally touches the third stopper.

For an embodiment, it was found during the evaluation that the first stopper 18 is never touched during ordinary operation and is therefore redundant, but still contributing to the overall reliability of the actuator by preventing possible electrode stiction. Thus, the maximum opening force is achieved slightly before the cantilever touches the second stopper, which is therefore the best position for interlocking the cantilevers. The opening force of design III with the stiffest cantilevers is displayed in FIG. 8 for the average simulated pull-in actuation voltage (49.5 V, without previously interlocked hooks), and for the average measured actuation voltage necessary to open the interlocked switching contacts (85.0 V). The simulated opening force developed by the electrostatic actuator reaches a maximum of 686 μN at the actuation voltage of 49.5 V, and 2180 μN at 85.0 V, respectively, demonstrating the potential of the actuator to create very large opening forces for overcoming contact stiction. The total switch resistance was determined by measurements to about 2.2, which is rather large for a micro machined switch with gold contacts. The main contribution of the resistance stems from the two cantilevers with a total length of 700 μm, consisting of high-resistive silicon (>4000 cm) covered with a thin gold coating layer only. The total resistance of the two cantilevers was estimated by calculations to be between 1.5 and 2.5.

The opening force of the three novel switch designs embodiments above was determined by simulation of the equivalent cantilever tip force at the measured interlocked deflection in the on-state, as explained above, or the adhesion force between the contacts was derived from the measured necessary opening voltage and the deflection of the two interlocked cantilevers, and the contact force between the interlocked cantilevers was determined by simulation of the cantilevers at the measured deflection in the on-state.

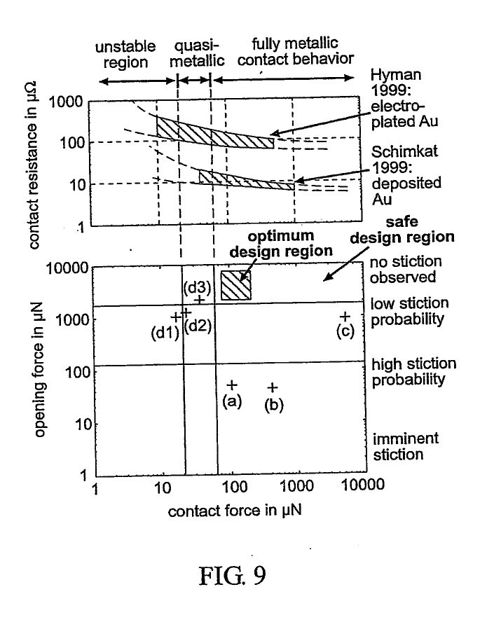

TABLE II
CONTACT AND RESTORING FORCES OF THE
SWITCH DESIGNS PLOTTED IN FIG. 9.

| | Fcont. | Frest | Fcont. | Spring constant |
|---|---|---|---|---|
| switch | μN | μN | Frest | k Nm⁻¹ |
| Radant (a)[21] | 100^{a} | 53^{b} | 2:1 | 100^{a} |
| HRL (b) [22] | 400^{a} | 46^{b} | 9:1 | 4-8^{a} |
| OMRON (c) [23] | 5000^{a} | 1000^{a} | 5:1 | 400^{a} |
| design I (d1) | 15^{c} | 1100^{d} | 1:73 | 3^{e} |
| design II (d2) | 22^{c} | 1210^{d} | 1:55 | 5^{e} |
| design III (d3) | 13^{c} | 2180^{d} | 1:70 | 7^{e} |

DATA DIRECTLY OBTAINED OR CALCULATED FROM THE LITERATURE (SWITCHES (A)-(C)), FROM SIMULATIONS OR DERIVED FROM MEASUREMENTS (SWITCH DESIGNS (D1), (D2) AND (D3)).
Where:
^{a}published data
^{b}calculated from published data: Frest. = k × dmax, with k the spring constant, and dmax the cantilever deflection in the on-state
^{c}superimposed simulated spring forces at the measured interlocked cantilever deflections
^{d}simulated equivalent electrostatic tip force at the average measured opening voltage, spring force already deducted
^{e}calculated from material parameters and measured cantilever dimensions

Table II summarizes the contact and opening forces of the three switch designs and compares these data to three conventional switch designs: an Analog Devices/Radant MEMS Inc. switch, the HRL switch, and a switch design by OM-RON Inc. The restoring spring forces, Frest, of the conventional switch designs are about 2-10 times smaller than their active contact forces, Fcont. In contrast to this, the opening forces, Frel, of the switch designs presented in these embodiments are not only larger than their contact forces Fcont, but even exceed the contact forces by a factor of 55 to 73. The opening forces of the new switch designs for the actuation voltages as stated above are between 1100 and 2180 μN. The contact forces are relatively small and between 15 and 31 μN. However, even a small contact force of 15 μN was found to result in a metallic contact behaviour with a contact resistance stable within 20 m, measured at a signal current of 1 mA. The total resistance of the closed switch is about 2.2 with its main contribution from the thin gold coating and the long silicon cantilevers.

FIG. 9, lower part, shows a double-logarithmic diagram plotting the area of possible microswitch designs spread out over the opening-force and the contact-force. Different design regions have been classified by the opening force according to the probability for contact stiction of gold contacts, and by the contact force according to the conductive behaviour of pure gold contacts exposed to low contact forces, according to previous investigations. The ‘safe design region’ is the region with the contact force larger than the minimum force required for fully metallic contact behaviour, and the opening force larger than the typical adhesive forces occurring between gold contacts as reported in the literature. The area just to the right of the minimum contact force line and just above the minimum opening force line is classified by the authors as the ‘optimum design region’, i.e. the forces are large enough for providing with sufficient contact reliability, but the actuator is definitively not yet oversized, which is the case for switch designs out of the parameter area more to the right in the safe design region. The resistance of gold micro contacts corresponding to the contact force is plotted above the diagram for two different studies as reported in the literature.

The six switch designs which are discussed in this section and listed in Table II are also plotted in the opening force/contact-force diagram of FIG. 9. The switch designs (a), Analog Devices/Radant MEMS, and (b), HRL, are less suitable for pure gold contacts but surely suitable for harder materials, since they develop relatively low opening forces. Out of the conventional switch designs, only (c), the OMRON switch, offers an opening force large enough to separate pure gold contacts, achieved at the cost of an oversized actuator with an unnecessarily large contact force. The novel switch designs presented in this paper, (d1)-(d3), come quite close to the optimum design region even though the contact force is rather on the lower side and needs some improvement, by increasing the cantilever stiffness, e.g.

The present embodiments report on a novel metal-contact switch concept with a large active opening force and a small, but sufficiently large passive contact force which makes this concept very suitable for soft-metal contact materials. Switches based on laterally moving, electrostatically actuated curved-electrode actuators have been fabricated in a true mechanically bi-stable configuration by a silicon-on-glass process. The switches have been evaluated by simulations and measurements and were compared in their contact-force/opening-force performance to switches of the conventional MEMS switch design with electrostatic actuation. In contrast to the conventional switch designs, the switches have been found to be very suitable for soft-metal contact materials because of their large opening force of up to 2.18 mN, which is large enough to break the adhesion force between gold contacts, and because of their passive contact force of 15-31 μN, which is, though rather on the lower end, still large enough to establish a stable contact resistance between the sputtered gold contacts.

### Additional Embodiments

An additional embodiment of a switch is based on laterally moving electrostatic curved-electrode actuators, and the mechanically multi-stable switch is either composed of two or of three interlocking, independently actuated hooks, resulting in a bi-stable or in a tri-stable mechanism, respectively. The bi-stable mechanism results in a single-pole-single-throw (SPST) switch, whereas the tri-stable mechanism leads to a true single-pole-double-throw (SPST) switch. The electrostatic actuators are only utilized to switch between the two (three) stable states and the switch maintains its positions when removing the external voltage source. The switches are placed in so-called in-line or three-terminal configuration, i.e. some electrical conducting parts of the switch, here the moving cantilever hooks, are both used as the signal path and as electrodes for applying the actuation voltage. Thus, the actuation voltage from, for example, a power feeder and the switched signal must be separated either in the frequency domain, or, making advantage of the mechanically bi/tri-stable structure, in the time domain.

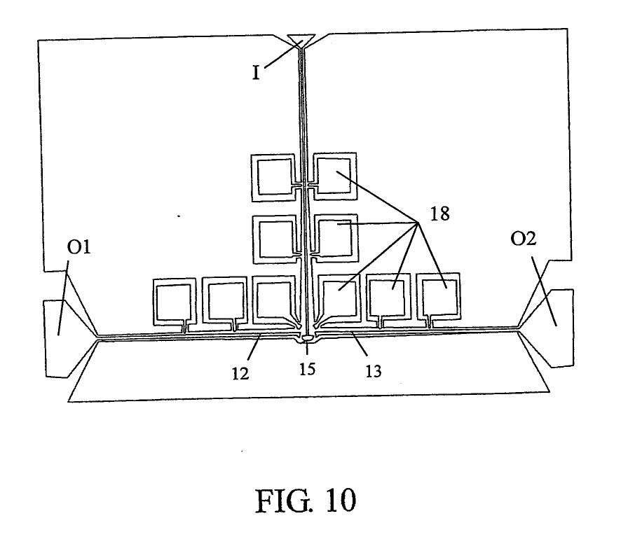

The switches are fabricated in an all-metal process which eliminates the need for isolation layers, but requires distance keeping stoppers along the fixed curved electrode, preventing the cantilevers from causing a short-circuit when snapping in. FIG. 10 shows the SEM-picture of a mechanically tri-stable, single-pole-double-throw (SPDT) switch comprising one input I and two outputs O1, O2 wherein the switch comprises one input 14 and two output 12, 13 cantilevers, thus three curved electrode actuators in total, whereas the middle actuator can move both to the left and to the right.

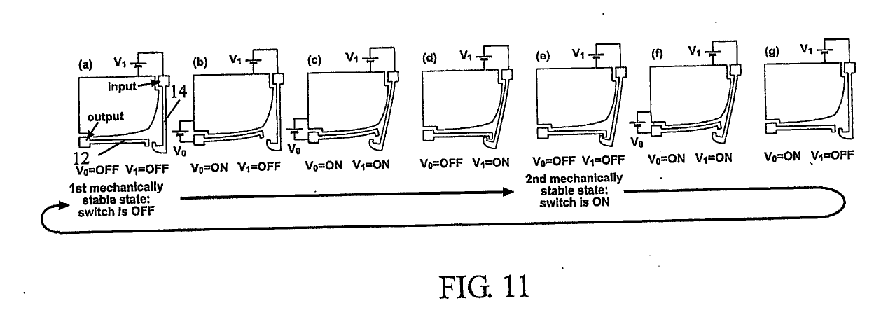

The actuation phases of the transition between the on and the off-state of the bi-stable switch configuration are shown in FIG. 11. Single actuation phases for switching the locking mechanism between the off-state to the on-state; for simplicity, shown for a single-pole-single-throw configuration (1 input, 1 output): (a) both the input and the output cantilever are released, off-state. To close the switch, the actuation voltage has to be applied first to the output cantilever (b), then also to the input cantilever (c), then removed from the output cantilever (d) and finally also from the input cantilever, resulting in the interlocked on-state of the switch (e). To open the switch, the actuation voltage has to be applied to both cantilevers (f), and subsequently removed first from the input cantilever (g), and finally also from the output cantilever, resulting in the initial off-state (a). Note that both actuation voltages are released for both the on-state and the off-state (Subfigure 11e and 11a, respectively).

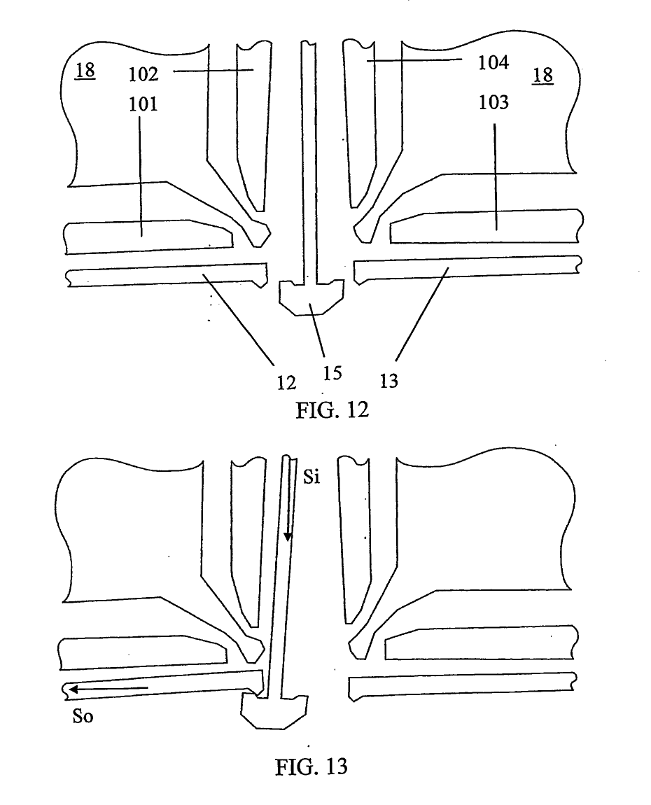

A close-up view of the centre section of the tristable SPDT switch is shown in FIG. 12. Close-up SEM-picture of the interlocking elements in the off-state; the cantilevers 12, 13, 15 have very low spring constants of less than 10 Nm-1, resulting in image jitter of the input cantilever 15 due to actuation by the electron beam in the SEM. The ground electrodes 101,102,103,104 are shown as well.

It should be understood that the electrostatic electrodes may be one electrode 10 arranged with two parts, a first part arranged along the first 12 and a second part arranged along the second 15 moving element, as it may in the embodiment of solely two cantilevers. A second electrode may as well be arranged to elongate along the second 15 and the third cantilever 13. That is, the switch comprises of one fixated electrode on each side of the second electrode.

FIG. 13 shows the switch in one of the two on-states. Here, the input cantilever 15 is interlocked with the left output cantilever 12, allowing for a signal flow from the input Si to the output 1 So. Close-up SEM picture of the interlocking elements in one of the two one states: input I closed to output 1 O1.

In contrast to other laterally moving microswitches based on a single curved electrode, which close the switching contacts in the deflected state of the cantilever [32], the strong electrostatic force in the end-position is not used to create the contact force of the presented switch design, but to open the switch with very large active opening forces, potentially providing with high contact reliability. The contact force is created by the passive spring force of the partly deflected cantilevers, as shown in FIG. 11e. Thus, unlike typical interlocking mechanisms in optical switches e.g., the hooks are not only utilized for mechanical bi-stability, but at the same time for creating the passive contact force between the switching contacts. The shape of the curved electrodes and the stopper positions have been optimized by using a numerical simulation algorithm developed for single-side clamped electrostatic actuators [33]. The design optimization criteria were to achieve sufficient deflection for generating the passive contact force, but still having large active opening forces to counteract contact stiction for good contact reliability. The same software was also used for simulating the pull-in voltages of the curved-electrode actuators.

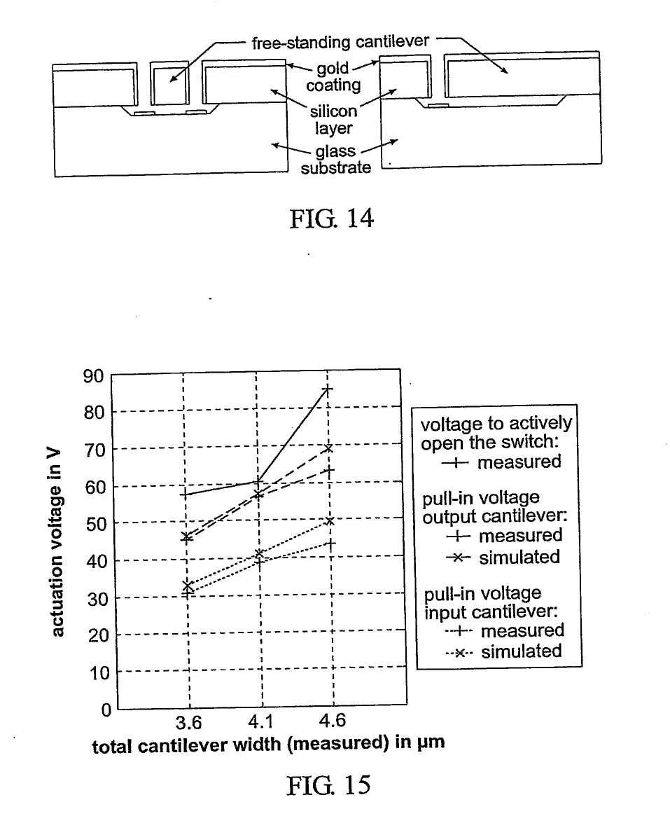

In an embodiment are the switches defined by a single photolithography mask and are fabricated based on a silicon-on-glass process. The structures are etched 60 μm deep into a silicon wafer using deep-reactive-ion-etching (DRIE) technique. Then, the silicon wafer is bonded to a glass wafer by anodic bonding, with the etched structures facing the glass wafer. Subsequently, the silicon substrate is thinned down by using combined grinding/polishing and a final potassium hydroxide (KOH) etch-step until the structures are fully exposed. The remaining silicon layer on the glass substrate is about 60 μm thick. Afterward, the structures are released by etching the frontside of the silicon-on-glass wafer in hydrofluoric acid aqueous solution (HF). At last, the structures are coated with sputtered Cr/Au with a thickness of 450 nm, measured on the sidewalls at a position with a gap of 17 μm between the coated structures. For gaps smaller than 5 μm, the metal coating thickness at the upper sidewalls is still about 400 nm. The metal coating on the top side of the silicon layer is about 700 nm. Due to the undercut of the isotropically etched glass wafer, the metal coating does not form a closed layer and geometrically isolated structures in the silicon device layer are also isolated electrically. FIG. 14 shows a lateral and a longitudinal cross-sectional view of a switch cantilever.

The measured and simulated actuation voltages of embodiments of the invention are plotted in FIG. 15, where it is plotted: actuation voltages for three switch designs with different cantilever thicknesses: pull-in voltages of the input and the output cantilevers, and voltage to open the switches. For a design variant with a measured silicon cantilever thickness of 2.8 μm and a gold coating of 2×400 nm, the measured pull-in voltages of the input and output cantilevers are 30.8 and 45.2 V, respectively, and are very well reproducible with standard deviations of 0.59 and 0.28 V of ten successive measurements. The simulated pull-in voltages of 33.1 and 46.3 V for the input and the output cantilevers, respectively, match the measured values very well. The actuation voltage to open the same switch variant is less stable and varies from 48 to 65 V for ten successive measurements, which is explained by the uncontrollable adhesion force between the metal contacts. The opening force of the electrostatic actuator of this switch variant was determined by simulations to be 1100 μN at an opening voltage of 57.3 V, corresponding to the average measured opening voltage. The self actuation voltages (switch closing when applying a voltage between the input and one of the output contact pads, without applying any actuation voltage) were determined by measurements to be 82.8, 57.3 and 32.68 V, for a total cantilever thickness of 4.6, 4.1 and 3.6 μm, respectively. It is assumed, however, that the cause of the self actuation is not the force developed between the small tips of the two cantilevers, but rather the electrostatic force between the cantilevers and their curved electrodes, which are electrically connected since they are made out of the same block in the silicon device layer, and are electrically floating between the input and the output cantilever potentials. If operated only in the two interlocked states input-to-1st-output and input-to-2nd-output (on-on), self actuation is completely prohibited.

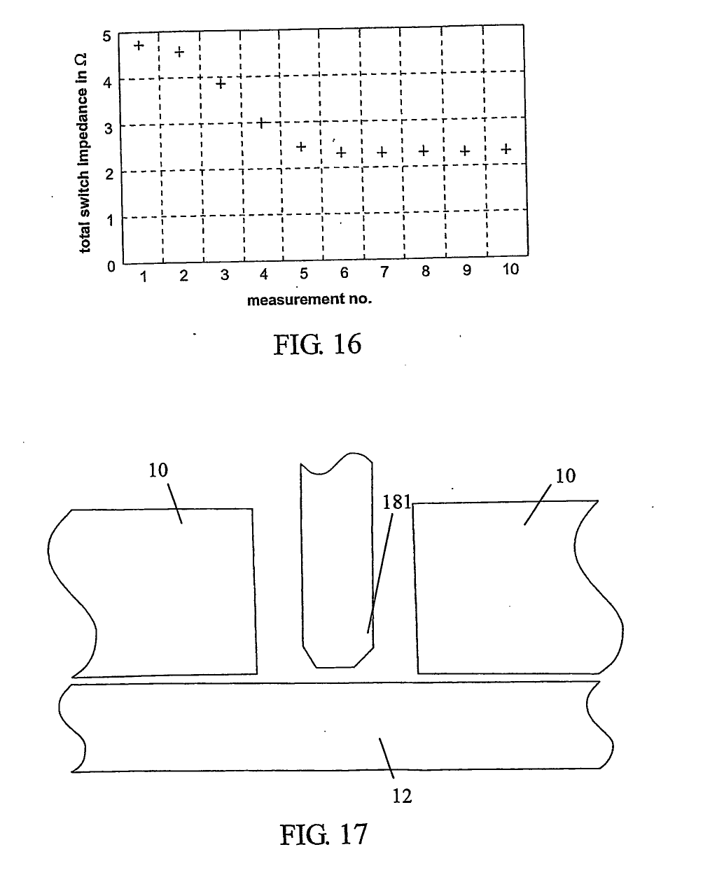

The total switch impedance of the first ten switching cycles with a cold-switched signal current of 1 mA is plotted in FIG. 16 that illustrates burn-in behaviour of the switching contacts: total switch impedance of the first ten switching cycles. After five cycles, the impedance drops to a constant value due to surface adaptation between the soft gold contacts. The impedance settles to stable 2.32 after about 5 burn-in cycles. It is assumed that this behaviour is caused by the contact surfaces which have to adapt to each other. The rather large total impedance of the switch is mainly contributed by the long low-conductivity silicon cantilevers coated with a thin gold layer only. Because of the large impedance, the current design is less suitable for RF switching applications with a typical system impedance of 50. For the switch variant with a measured cantilever thickness of 2.8 μm Si+2×400 nm Au, the passive contact force was estimated by simulations to be 15-20 μN, which is rather at the lower end for having a stable electrical contact for gold [34]. However, the experimental evaluation of the fabricated switches has proved that this low contact force is large enough for having a stable contact resistance, since the measured impedance is stable within less than 20 m after the initial burn-in.

For a switch design variant with a total cantilever thickness of 4.6 μm, the passive contact force and the active opening force are 31 and 2180 μN, respectively. Such very large opening forces are possible even for this small-scale actuator, because the curved-electrode actuators are utilized in their maximum-force position to open the switch. The large active opening force is able to counteract large contact adhesion forces, resulting in good contact reliability even for soft contact materials such as gold.

FIG. 17 shows a failure mechanism of a switch variant: the design resulted in stopper tips 181 being too short which lets the cantilever 12 touch the curved electrode 10, resulting in a short circuit and potentially permanent stiction of the cantilever 12 to the fixed electrode 10. The short tip 181 is a result of overetching of small structures as compared to larger structures, which was not compensated for in all switch design variants

This embodiment reports on a novel mechanically tri-stable, all metal microswitch based on laterally moving curved electrode actuators. The switches are designed in an in-line, true single pole-double-throw configuration and features active opening capability with three mechanically stable states: 1) input to first output; 2) switch off; 3) input to second output (on-off-on). The devices are fabricated in a silicon-on-glass process and are coated with sputtered gold, resulting in an all-metal switch. The switches feature active opening capability for which the curved-electrode actuators are utilized in their end-position where they develop their maximum force to guarantee a very large opening force which makes the switch less susceptible for contact stiction or large contact adhesion forces.

It should be understood that in another embodiment the switch may be configured to position the moving elements interconnected to each other, that is, a state where the second moving element is interconnected to the first moving element and the third moving element.

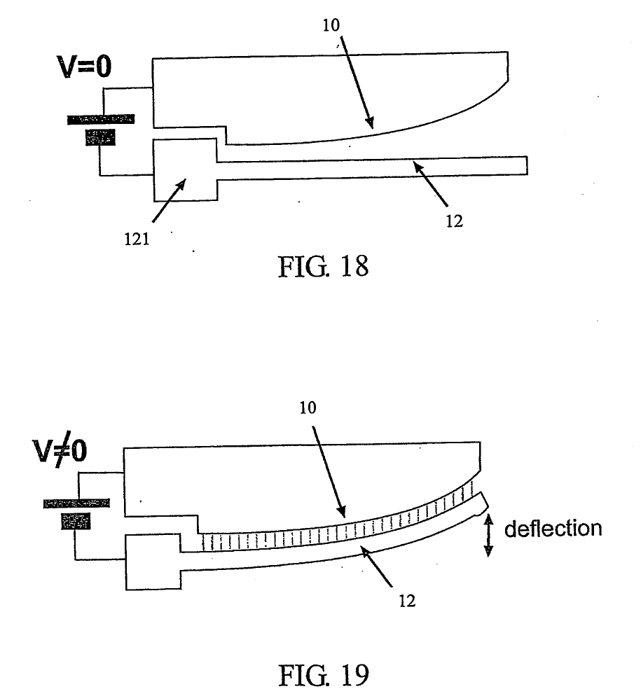

FIG. 18 and FIG. 19 show the typical concept of a curved-electrode actuator, consisting of a rigid or fixated, curved electrode and a flexible and movable, typically initially straight movable structure or element acting as the second electrode: FIG. 18 shows a curved electrode actuator with no voltage applied between the electrodes, thus not deflected or actuated.

FIG. 19 shows the curved electrode actuator with a voltage applied between the two electrodes 10, 12, resulting in an electrostatic force between the movable element 12 and the rigid curved electrode 10, and resulting in a deflection of the movable structure (cantilever) 12, and with the electrostatic force between the two electrodes increasing with increased deflection;

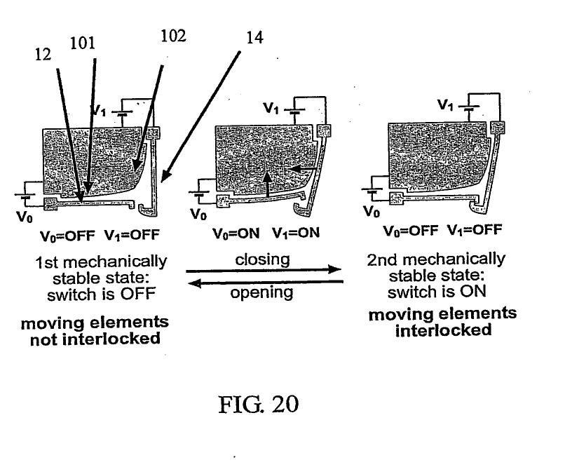

FIG. 20 shows a typical switch device based on two curved electrode actuators with one movable element each 12, 14, where the movable elements 12, 14 can be interlocked (second mechanically stable state as shown in the figure) or not interlocked (first mechanically stable state). Electrically, this configuration results in a mechanically bi-stable single-pole-single-throw switch, which is a switch with one single input and one single output where one stable state is the on-position (connection of the input to the output) and the other stable state is the switch in the off-position (input electrically not connected to the output). The transition between the two stable states is achieved by deflecting the movable structures along their corresponding curved electrodes 101, 102. For the device as shown in the figure, the two curved electrodes 101, 102 are electrically connected to each other. In other embodiments, the curved electrodes are not electrically connected. V=ON refers to applying a voltage (=potential difference) between the two elements, V=OFF means not applying a voltage (=bringing both elements to the same electrical potential).

Referring back to FIG. 11 where the actuation sequence of operating the device as shown in FIG. 20 between the two mechanically stable states is shown.

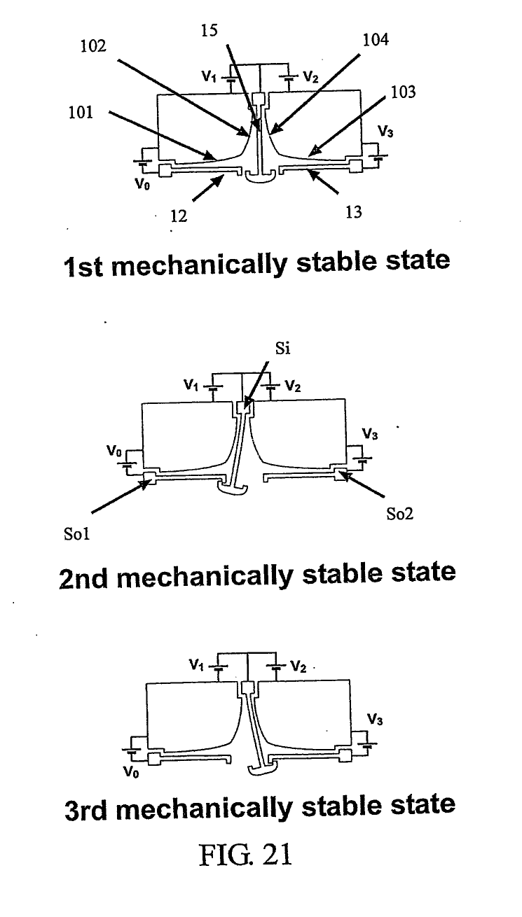

FIG. 21 shows a configuration with four curved-electrodes 101, 102, 103, 104 and three moving elements 12, 13, 15, where the middle moving element 15 can be deflected (moved) to either one of the two curved electrodes 102, 104 beside it. This results in a mechanically tri-stable switch with the following mechanically stable states: (1) none of the moving structures are interlocked, (2) middle moving structure 15 interlocked to left moving structure 12; (3) middle moving structure 15 interlocked to the moving structure on the right 13. If the input of the electrical signal Si is put on the middle moving structure and the left moving structure is electrically connected to output no. 1, signal output 1, So1 and the right moving structure is electrically connected to the output no. 2, signal output 2So2, than this device configuration results in a single-pole-double-through switch, which is a switch with one input and two outputs, and the input can be connected to either one of the two outputs (states (2) and (3)), or not connected to any output at all (state (1)). The figure shows all three mechanically bi-stable states.

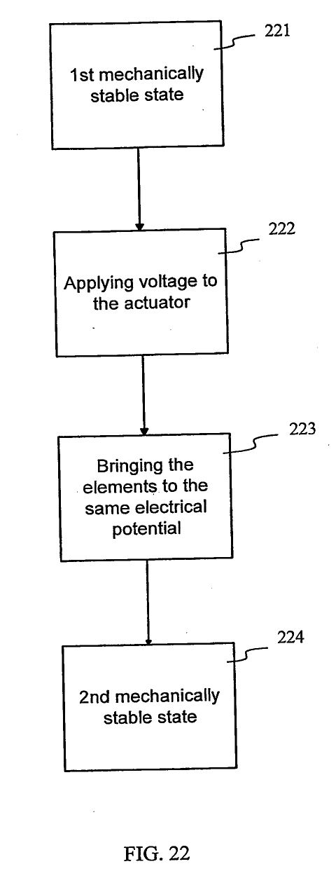

FIG. 22 discloses a flow chart of a method of moving the switch from one mechanically stable state to another mechanically stable state.

In step 221, the switch is in a 1^{st} mechanically stable state.

In step 222, the switch is applied with a voltage, that is, the cantilever and the curved electrode is applied with a potential difference, resulting in that the movable structures are deflected along their corresponding curved electrode. In an embodiment the applying of voltage occurs simultaneously, according to FIG. 20, and in another embodiment the applying of voltages follows a certain sequence to achieve aimed stable states, for example, see FIG. 11.

In step 224, no voltage is applied to the switch elements or the same voltage is applied to the elements, bringing the elements of the switch to the same electrical potential. As stated in step 222, this may occur simultaneously between the elements or in a certain sequence.

In step 226, the switch is then positioned in a 2^{nd} mechanically stable state.

It should be noted that the flow may be applied for opening the switch as well as closing the switch.

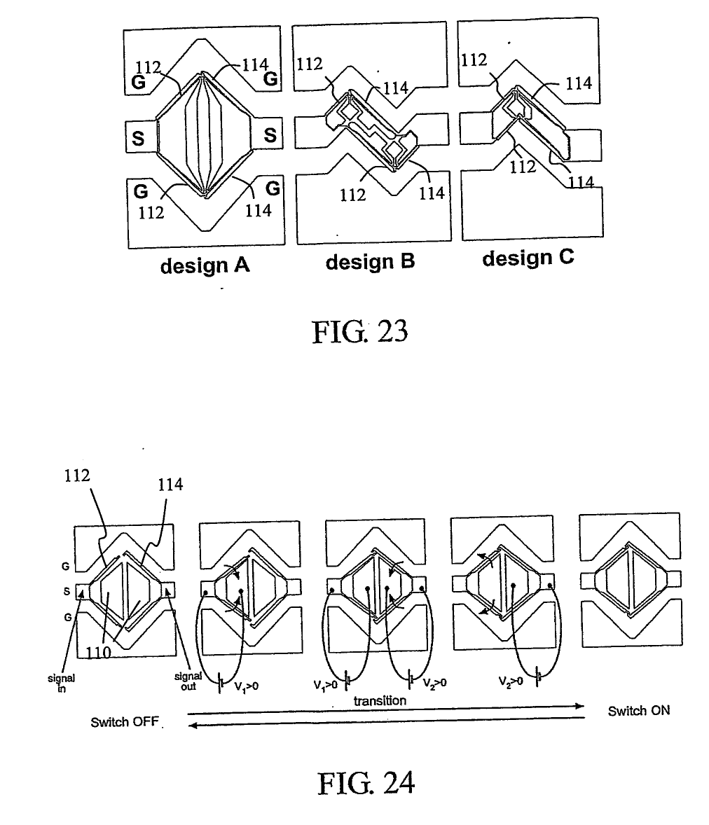

FIG. 23 shows three (design A, B, and C) possible embodiments of the mechanically bi-stable switch mechanism utilized for switching an radio-frequency or microwave transmission line of any frequency range, here exemplarily shown for a coplanar waveguide type transmission line, where the signal line of the waveguide is accompanied by two ground lines on the sides of the signal line. In all three examples, the signal line is interrupted between the input (left) and the output (right), which is the off-state of the switches, and the signal line can be closed, which is the on-state of the switches, by interlocking the two switch mechanisms 112, 114 on each edge of the signal line, wherein each of the switch mechanisms is based on the interlocking, mechanically bi-stable mechanism actuated by curved-electrode actuators as described in this invention. The different designs showed are in an on-state.

It should be understood that the switch mechanism may solely comprise a single interlocking mechanism, for example, one pair of the cantilevers 112, 114 in FIG. 23, such as a slot line.

FIG. 24 shows the actuation phases needed for the transition between the on-state and the off-state for the radio-frequency signal suitable switch design A of FIG. 23. The actuation phases are depicted for switching both switch mechanisms (on each edge of the signal line of the coplanar waveguide) simultaneously. The spring force and the hooked tip of the first cantilever 112 is keeping the contact between the both cantilevers 112, 114.

The present invention relates to actuation of a switch of electrical signals. Especially, the actuation of a MEMS switch is disclosed. The actuator mechanism comprises of a first moving element 12, a second moving element 14, and electrostatic electrodes, especially curved electrodes, arranged along the moving elements. The switch is allowed to take at least two mechanically stable positions, i.e. positions which are maintained without applying any external or internal actuation energy or force: one position when the switch is closed and the electrical signal is running through the switch, and another position when the switch is open and the signal is not able to run through the switch. More than two mechanically stable states are possible for a switch with more than one signal input port, or more than one signal output port, or more than one signal input and more than one signal output port. The switch is transitioning from one mechanically stable state to another by applying at least one or a sequence of electrical potential differences (voltage) between at least one moving element and at least one of the fixated electrodes (such as curved electrodes), forcing at least one of the moving elements to deflect due to electrostatic forces towards the fixated electrode as stated above. The actuation mechanism is very energy efficient not requiring any energy or power when resting in the mechanically stable states, and only requiring a reconfiguration in the potential differences between the actuation electrodes, i.e. the actuation power (current) and due to the actuation mechanism the sizing of the switch may be reduced, thereby, resulting in that the actuation mechanism is very well used in a switch matrix forming arrays of switches.

It should also be understood that the signal line may be separated from the actuator elements, as stated above. That is, the signal line may be mechanically attached to a cantilever of the actuator mechanism.

In an alternative embodiment may one single electrode work with only one moving part (but there are two moving parts in the system); wherein a certain voltage creates one interlocked state, and applying an even larger voltage results in a release of the interlocking mechanism. E.g., only one cantilever is actively moved, and at a position about half of the deflection it results in a mechanically interlocked state with a movable, but not actively actuated cantilever (like snapping in), and when the first cantilever is further actuated, the snapping mechanism opens again.

The foregoing has described the principles, preferred embodiments and modes of operation of the present invention. However, the invention should be regarded as illustrative rather than restrictive, and not as being limited to the particular embodiments discussed above. It should therefore be appreciated that variations may be made in those embodiments by those skilled in the art without departing from what is stated in the following claims.

1-21. (canceled)

22. A multi stable switch arranged to switch the configuration of the signal path for electrical signals, comprising:
a signal input;
a signal output;
a first moving element; and
a second moving element,
wherein the first and second element are arrangeable into at least two mechanically stable states:
a mechanical interlocked state, wherein the first moving element is mechanically interlocked with the second moving element wherein a signal path in the switch is arranged in a closed configuration forming a transmission path, enabling transmission of electrical signals from the signal input to the signal output of the switch; and
a non interlocked state, wherein the first moving element is separated from the second moving element and the signal path in the switch is arranged in an open configuration;
wherein the switch further comprises:
a fixated electrostatic electrode configured with a first fixated electrode part arranged to actuate and move at least one of the first and second moving elements when an electrical potential difference is applied between the first fixated electrode and at least one of the moving elements, transitioning the moving elements from one state to another.

23. A multi stable switch according to claim 22, wherein the switch is a laterally moving switch.

24. A multi stable switch according to claim 22, wherein the first fixated electrostatic electrode further comprises a second fixated electrostatic electrode part arranged along the second moving element and the first fixated electrode part is arranged along the first moving element.

25. A multi-stable switch according to claim 22, wherein the moving elements have one fixating anchor point each arranged at a small distance from the fixated electrode, and a tip arranged at a greater distance than the anchor point from the fixated electrode.

26. A multi-stable switch according to claim 25, wherein the tips of the moving elements are arranged in shapes to assist the interlocking between the first moving element and the second moving element.

27. A multi-stable switch according to claim 22, comprising a restoring mechanical spring, and wherein the interlocked state of the moving elements is maintained by a force created by the restoring mechanical spring force of at least one of the moving element that is deflected in the mechanically interlocked state.

28. A multi-stable switch according to claim 22, wherein the switch comprises distance keepers or dielectric isolation layers arranged to separate the fixated electrostatic electrode and at least one of the moving elements.

29. A multi-stable switch according to claim 22, wherein the switch is further arranged to switch the electrical signal between an input and two outputs or between two inputs and an output.

30. A multi-stable switch according to claim 22, wherein the switch comprises a third moving element and the fixated electrostatic electrode comprises a third fixated electrode part arranged to deflect the third moving element towards the third fixated electrode part when an electrical potential difference is applied between the third moving element and the third fixated electrostatic electrode part, and wherein the first, second and third element can be arranged into at least three stable states:
the mechanical interlocked state, wherein the first moving element is interlocked with the second moving element;
a second mechanical interlocked state, wherein the second moving element is interlocked with the third moving element; and
the non interlocked state, wherein none of the moving elements is interlocked to any of the other moving elements.

31. A multi stable switch according to claim 22, wherein the switch is a MEMS switch.

32. A multi-stable switch according to claim 22, wherein the moving elements have a shape of a cantilever beam.

33. A multi-stable switch according to claim 24, wherein the electrode parts of the fixated electrostatic electrode are separate electrodes electrically separated from each other.

34. A multi-stable switch according to claim 22, wherein the fixated electrode part is curved.

35. A multi stable switch according to claim 22, wherein each moving element comprises a signal path arrangement and an actuation electrode wherein the signal path arrangement is separated from the actuation electrode on the moving elements.

36. A switch according to claim 22, wherein the elements of the arrangement, including the fixated electrode, are arranged in a way that the disturbance of the signal propagation of high frequency signals, including microwave and millimeter wave, is minimized.

37. A switch according to claim 22, wherein the switch is embedded inside a signal line which is a part of a transmission line.

38. A method for the transition of a switch configuration from a first stable state to a second stable state wherein a transmission path is established for an electrical signal to transfer from an input to an output of the switch, the method comprising:
applying an electrical potential difference between a first fixated electrostatic electrode and a first moving element,
forcing the first moving element to deflect towards the first fixated electrode by electrostatic force; and
releasing the electrical potential difference resulting in that the first and second moving element are positioned into the second stable state.

39. A method according to claim 38, wherein the first and second stable states are:
a mechanical interlocked state, wherein the first moving element is interlocked with the second moving element and an electrical signal path in the switch is non interrupted; and
a non interlocked state, wherein the first moving element is separated from the second moving element and the electrical signal path in the switch is interrupted.

40. A method according to claim 38, comprising:
applying an electrical potential difference between a second fixated electrostatic electrode part and the second moving element, forcing the second moving element to deflect towards the second fixated electrode by electrostatic force; and
releasing the electrical potential difference between the second fixated electrostatic electrode part and the second moving element.

41. A method according to claim 38, wherein the applying and releasing of electrical potential difference between the first fixated electrostatic electrode part and the first moving element and the applying and releasing of electrical potential difference between the first fixated electrostatic electrode part and the second moving element are following a certain sequence.

42. A method according to claim 38, wherein the method comprises:
applying an electrical potential difference between a third fixated electrostatic electrode part and a third moving element, forcing the third moving element to deflect towards the third fixated electrostatic electrode part by electrostatic force; and
releasing the electrical potential difference between the third fixated electrostatic electrode part and the third moving element, resulting in that the first and/or the second moving element, and the third moving element are arranged in a third stable state interconnected to each other.

43. A method according to claim 38, wherein the electrode parts of the electrostatic electrode are separated parts.

44. A system arranged to switch electrical signals comprising a first and a second multi stable switch according to claim 22, arranged adjacent to each other forming an array of switches in a switch matrix.
